(19) United States
(12) Patent Application Publication
(10) Pub. No.: US 2026/0278460 A1
(43) Pub. Date: Sep. 17, 2026

(54) RECOGNITION MODEL BUILDING METHOD, BANK CARD NUMBER RECOGNITION METHOD, AND RELATED PRODUCTS THEREOF

(71) Applicants: Nanjing Xiyin Ecommerce Co., Ltd., Jiangsu (CN); Guangzhou Xiyin International Import and Export Co., Ltd., Guangdong (CN); Shenzhen Xiyin Information Technology Co., Ltd., Guangdong (CN)

(72) Inventors: XIAOHU HUANG, Jiangsu (CN); ZUOPENG LIU, Jiangsu (CN); GEYANG KE, Jiangsu (CN); WEIZHAO GUO, Jiangsu (CN); XINGGUO MA, Jiangsu (CN)

(21) Appl. No.: 19/312,479

(22) Filed: Aug. 28, 2025

(30) Foreign Application Priority Data
Mar. 12, 2025 (CN) 2025102931735

(51) Int. Cl. G06N 20/00

(52) U.S. Cl. CPC G06N 20/00

(57) ABSTRACT

A recognition model building method includes acquiring an initial bank card dataset and a background dataset, performing data enhancement on the initial bank card dataset with the background dataset to obtain a bank card dataset, and building a multitask recognition model from the bank card dataset. Data enhancement is performed on the initial bank card dataset with the background dataset to obtain a bank card dataset with abundant and diverse samples.

### CROSS-REFERENCE TO RELATED APPLICATION AND CLAIM OF PRIORITY

This application claims the benefit under 35 USC §119 of Chinese Patent Application No. 2025102931735, filed on Mar. 12, 2025, in the China Intellectual Property Office, the entire disclosure of which is incorporated herein by reference for all purposes.

### BACKGROUND

### 1. Technical Field

The present disclosure generally relates to the technical field of image processing. More particularly, the present disclosure relates to a recognition model building method, a bank card number recognition method, and related products thereof.

### 2. Background Art

With the popularization and development of the mobile internet and e-commerce, more and more users choose to shop online at a mobile terminal, where after an item is selected, the user proceeds to checkout via mobile payment. However, before payment, the user often needs to manually input his/her bank card number on a platform to bind the bank card under his/her name with the platform. The binding process of manually inputting the card number is extremely complicated, but also prone to input errors, leading to poor use experience of the user.

In recent years, the development of deep learning has strongly promoted the progress of the optical character recognition (OCR) technology, which has exhibited excellent performance in text recognition. The OCR technology acquires an image through an optical device such as a scanner, a camera, and the like, and then processes text in the image to recognize characters including letters, numbers, symbols, and the like in the image. Therefore, by applying the OCR technology to bank card number recognition, manual input of the user can be effectively reduced, and the efficiency of bank card number recognition can be improved. However, in a consumer end (C-End) scene, the user's use environment is characterized by complexity and diversity, where uncertain factors, such as uneven illumination, inclined shooting angles, background interference and image blurring, are extensive. The uneven illumination may cause a large brightness difference in the bank card number region, making it difficult to clearly image some characters. The inclined shooting angle may cause distortion of card number characters, thereby increasing the recognition difficulty. The complex background interference may cause a recognition algorithm to mistakenly regard elements in the background as card number characters. The image blurring may lead to unclear edges and lost details of characters. These adverse factors will greatly influence the extraction and judgment of the OCR recognition algorithm on features of the bank card number, and further lead to a greatly reduced accuracy when the recognition mode is applied to bank card number recognition.

In view of this, there is an urgent need for a recognition model building method, a bank card number recognition method, and related products thereof, which can improve the efficiency and accuracy of bank card number recognition.

### SUMMARY

To address at least one or more of the above technical problems, the present disclosure proposes, in various aspects, a recognition model building method, a bank card number recognition method, and related products thereof, aiming to improve the accuracy of bank card number recognition.

In a first aspect, the present disclosure provides a recognition model building method, including: acquiring an initial bank card dataset and a background dataset; performing data enhancement on the initial bank card dataset with the background dataset to obtain a bank card dataset; and building a multitask recognition model from the bank card dataset.

In some embodiments, the multitask recognition model includes a card key point detection model, a card number detection model, and a card number recognition model; the bank card dataset includes a card key point detection dataset, a card number detection dataset and a card number recognition dataset used for building the card key point detection model, the card number detection model, and the card number recognition model, respectively; the card key point detection dataset is labeled with a bank card detection box and bank card vertex positions; the card number detection dataset is labeled with a bank card number region; the card number recognition dataset is labeled with a bank card number region and a bank card number displayed in the region; and building the multitask recognition model from the bank card dataset includes: training a first preset model with the card key point detection dataset to obtain the card key point detection model; training a second preset model with the card number detection dataset to obtain the card number detection model; and training a third preset model with the card number recognition dataset to obtain the card number recognition model.

In some embodiments, performing data enhancement on the initial bank card dataset with the background dataset to obtain the bank card dataset includes: performing image segmentation on the initial bank card dataset to extract a bank card image; performing enhancement transformation on the bank card image, wherein the enhancement transformation includes at least one of random rotation, scaling, Hue Saturation Value (HSV) transformation, perspective transformation, blurring or texture addition; randomly synthesizing the bank card image after the enhancement transformation with a background image in the background dataset to obtain a simulated bank card dataset; and merging the simulated bank card dataset and the initial bank card dataset to obtain the bank card dataset.

In some embodiments, after merging the simulated bank card dataset and the initial bank card dataset to obtain the bank card dataset, the method further includes: labelling the bank card dataset based on a type of bank card dataset to obtain a target bank card dataset corresponding to the type; wherein if the target bank card dataset is a card key point detection dataset, a bank card detection box and bank card vertex positions are labeled to the bank card dataset; if the target bank card dataset is a card number detection dataset, a bank card number region is labeled to the bank card dataset; and if the target bank card dataset is a card number recognition dataset, a bank card number region and a bank card number displayed in the region are labeled to the bank card dataset.

In some embodiments, after building the multitask recognition model from the bank card dataset, the method further includes: converting the multitask recognition model into an NCNN (Neural Compute Neural Network) model by an NCNN framework.

In a second aspect, the present disclosure provides a bank card number recognition method using a recognition model built in the method according to the first aspect and any embodiment thereof, including: acquiring an input image from a user; and recognizing a bank card number in the input image by the multitask recognition model to obtain a recognition result of the bank card number.

In some embodiments, the multitask recognition model includes a card key point detection model, a card number detection model, and a card number recognition model; recognizing the bank card number in the input image by the multitask recognition model to obtain the recognition result of the bank card number includes: performing card key point detection on the input image by the card key point detection model to obtain a card key point detection result, wherein the card key point detection result includes a bank card detection box; clipping the input image according to the bank card detection box to obtain a bank card image; performing card number detection by the card number detection model on the bank card image to obtain a bank card number region; and performing card number recognition by the card number recognition model on the bank card number region in the bank card image to obtain the recognition result of the bank card number.

In some embodiments, the card key point detection result further includes bank card vertex positions; before clipping the input image according to the bank card detection box to obtain the bank card image, the method further includes: acquiring reference bank card vertex positions in a preset standard environment; determining a perspective transformation matrix according to a positional relationship between the bank card vertex positions and the reference bank card vertex positions; and performing perspective transformation on the input image by the perspective transformation matrix to obtain a corrected input image.

In some embodiments, the card key point detection result further includes bank card vertex positions, and after performing bank card target detection and bank card vertex position detection on the input image by the card key point detection model to obtain the card key point detection result, the method further includes: judging whether the bank card detection box is present in the card key point detection result; if the bank card detection box is present, determining a number of bank card vertex positions; if the number of bank card vertex positions is a preset threshold, performing the step of clipping the input image according to the bank card detection box to obtain the bank card image; if the number of bank card vertex positions is not a preset threshold, skipping to the step of acquiring an input image from the user; and if the bank card detection box is not present, skipping to the step of acquiring an input image from the user.

In some embodiments, the multitask recognition model is an NCNN (Neural Compute Neural Network) model; and before recognizing the bank card number in the input image by the multitask recognition model to obtain the recognition result of the bank card number, the method further includes: deploying the multitask recognition model.

In a third aspect, the present disclosure provides a processing apparatus, including: a processor configured to execute program instructions; and a memory configured to store program instructions which, when loaded and executed by the processor, cause the processor to perform the recognition model building method according to the first aspect of the present disclosure and any embodiment thereof, and the bank card number recognition method according to the second aspect of the present disclosure and any embodiment thereof.

In a fourth aspect, the present disclosure provides a non-transitory machine-readable storage medium having program instructions stored thereon which, when loaded and executed by a processor, cause the processor to perform the recognition model building method according to the first aspect of the present disclosure and any embodiment thereof, and the bank card number recognition method according to the second aspect of the present disclosure and any embodiment thereof.

With the recognition model building method provided above, in the embodiments of the present disclosure, data enhancement is performed on the initial bank card dataset with the background dataset to obtain a bank card dataset with abundant and diverse samples, and then a multitask recognition model is built from the bank card dataset. It will be appreciated that the bank card dataset with abundant and diverse samples can provide rich and diverse sample examples for the building of the multitask model. By means of these samples, the model can thoroughly learn and adapt to features and modes of the bank card under various complex environmental conditions, such as uneven illumination, inclined shooting angles, complex backgrounds, image blurring and the like, and therefore the generalization capability and recognition accuracy of the model are improved in practical applications. Therefore, when the multitask recognition model is applied to bank card number recognition, the bank card number can be accurately recognized based on the input image without manually inputting the bank card number by a user, thereby achieving the effect of improving the efficiency and accuracy of bank card number recognition.

### BRIEF DESCRIPTION OF THE DRAWINGS

The above and other objectives, features and advantages of the exemplary implementations of the present disclosure will become readily apparent from the following detailed description, which proceeds with reference to the accompanying drawings. In the accompanying drawings, several implementations of the present disclosure are illustrated by way of example but not limitation, and like or corresponding reference numerals indicate like or corresponding parts, in which:

FIG. 1 shows an exemplary flowchart of a recognition model building method according to some embodiments of the present disclosure;

FIG. 2 shows an exemplary flowchart of a recognition model building method according to some embodiments of the present disclosure;

FIG. 3 shows an exemplary flowchart of a recognition model building method according to some embodiments of the present disclosure;

FIG. 4 shows an exemplary flowchart of a recognition model building method according to some embodiments of the present disclosure;

FIG. 5 shows an exemplary flowchart of a bank card number recognition method according to some embodiments of the present disclosure;

FIG. 6 shows an exemplary flowchart of a bank card number recognition method according to some embodiments of the present disclosure;

FIG. 7 shows an exemplary flowchart of a bank card number recognition method according to some embodiments of the present disclosure;

FIG. 8 shows a general exemplary flowchart of steps in a bank card number recognition method according to some embodiments of the present disclosure;

FIGS. 9A to 9F show output images corresponding to steps in a general exemplary flowchart of steps in a bank card number recognition method according to some embodiments of the present disclosure; and

FIG. 10 shows an exemplary block diagram of an electronic device according to an embodiment of the present disclosure.

### DETAILED DESCRIPTION

The technical solutions in the embodiments of the present disclosure will be clearly and completely described below with reference to the accompanying drawings in the embodiments of the present disclosure. Apparently, the described embodiments are only part, but not all, of the embodiments of the present disclosure. All other embodiments, which can be derived by those skilled in the art from the embodiments of the present disclosure without making any creative effort, shall fall within the protection scope of the present disclosure.

It will be understood that the terms "comprise" and "include", when used in the description and claims of the present disclosure, specify the presence of the stated features, integers, steps, operations, elements, and /or components, but do not preclude the presence or addition of one or more other features, integers, steps, operations, elements, components, and /or groups thereof.

It is also to be understood that the terminology used in the description of the present disclosure herein is for the purpose of describing particular embodiments only, and is not intended to be limiting of the present disclosure. As used in the specification and claims of the present disclosure, the singular forms "a", "an" and "the" are intended to include the plural forms as well, unless the context clearly indicates otherwise. It should be further understood that the term "and/or" as used in the description and claims of the present disclosure refers to any and all possible combinations of one or more of the associated listed items and includes such combinations.

As used in this specification and claims, the term "if" may be interpreted as "when" or "once" or "in response to determining" or "in response to detecting" depending on the context. Similarly, the phrase "if it is determined" or "if [the described condition or event] is detected" may be interpreted contextually as meaning "upon determining" or "in response to determining" or "upon detecting [the described condition or event]" or "in response to detecting [the described condition or event]".

Specific implementations of the present disclosure will be described in detail below with reference to the accompanying drawings.

### Exemplary application scenarios

During checkout or transfer payment operations at a mobile terminal, a user needs to bind a bank card under his/her name with the corresponding platform in advance. Subsequent payment can be smoothly performed only after the binding process is completed. Current binding of the bank card still requires the user to manually input the bank card number. The binding process of manually inputting the card number is not only complicated, but also prone to input errors, thereby impairing the user's use experience.

The OCR technology acquires an image through an optical device such as a scanner, a camera, and the like, and processes the text therein to accurately recognize various characters such as letters, numbers, symbols and the like. With the continuous development of technology, OCR exhibits excellent performance in the field of text recognition. By applying OCR to bank card number recognition, manual input of the user can be effectively reduced, and the recognition efficiency can be significantly improved.

However, at the Customer-end, the user's use environment is complex and diverse, where various adverse factors, such as uneven illumination, inclined shooting angles, background interference and image blurring, are present. These adverse factors will greatly interfere with the extraction and judgment of the recognition algorithm on features of the bank card number, and greatly reduce the accuracy of the recognition mode in bank card number recognition, thereby failing to meet the actual application requirements.

### Exemplary application schemes

In view of this, an embodiment of the present disclosure provides a recognition model building method, which acquires an initial bank card dataset and a background dataset, and performs data enhancement on the initial bank card dataset with the background dataset to obtain a sufficient bank card dataset, where the bank card dataset covers various usage scenarios, and includes samples collected under various adverse factors such as uneven illumination, oblique shooting angles, complex background interference, and image blurring. Then, the bank card dataset is used to build a multitask recognition model which can be used for bank card number recognition and has excellent recognition accuracy.

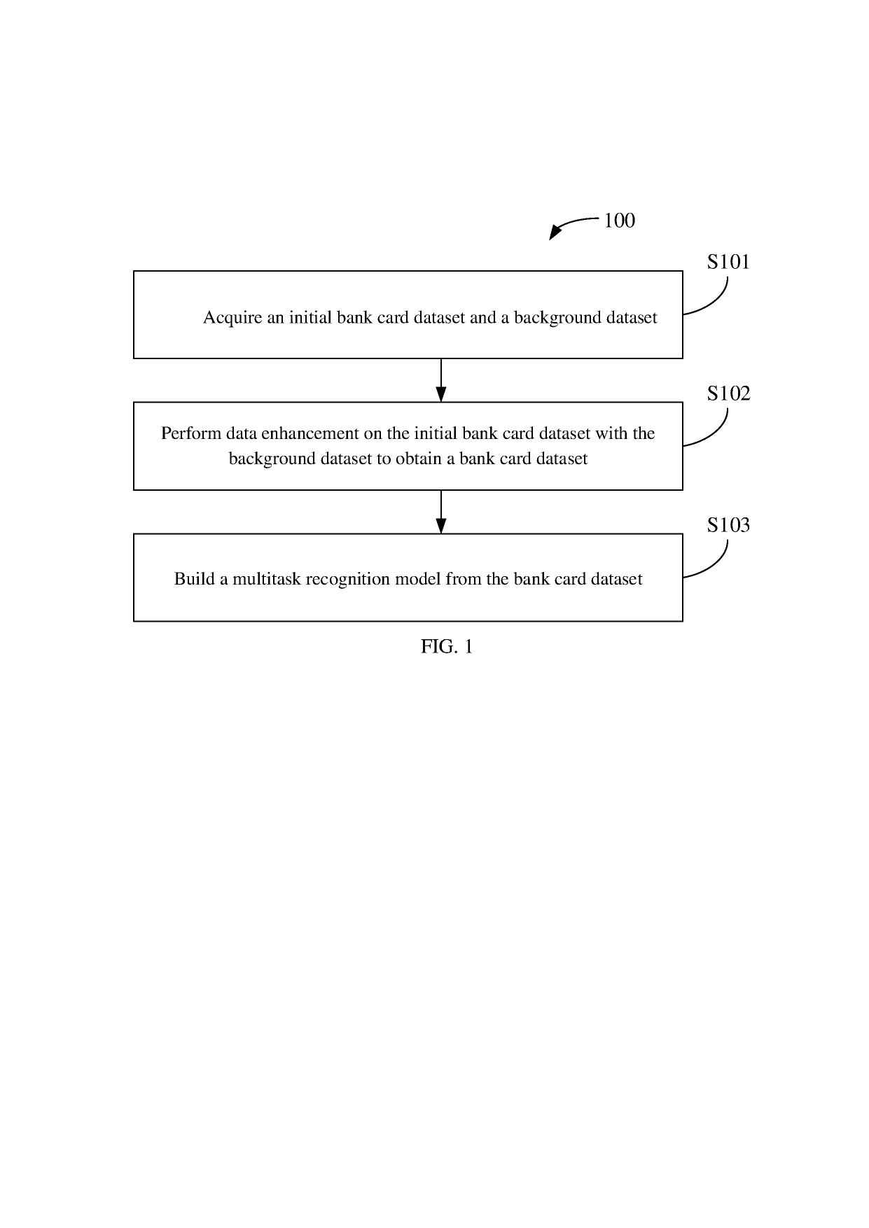

FIG. 1 shows an exemplary flowchart of a recognition model building method 100 according to some embodiments of the present disclosure. As shown in FIG. 1, the method 100 includes steps S101 to S103. Firstly, in step S101, an initial bank card dataset and a background dataset are acquired. In an embodiment of the present disclosure, the initial bank card dataset consists of images of real bank cards of users. The background dataset consists of various types of background images.

Further, the initial bank card dataset may be acquired through manual collection, a web crawler and the like. The web crawler, also called web spider or web robot, is a program or script for automatically capturing web information based on a certain rule. It will be appreciated that the initial bank card dataset can be quickly obtained by a web crawler. In addition, the background dataset may be self-collected, or may be selected from existing background image resources available on the market. As an example, rich image resources provided by open source datasets like Image Network (imagenet), Microsoft Common Objects in Context (CoCO) and Places365-CNNs for scene classification (place365) may be used as the background dataset.

As bank cards are typically concerned with user privacy, it is often difficult to obtain a sufficient initial bank card dataset. However, if the dataset for building the multitask model is insufficient, and the adverse factors, such as uneven illumination, inclined shooting angles, complex backgrounds, and image blurring as mentioned above, are not fully considered in data acquisition, the recognition accuracy of the model will be directly and greatly reduced.

Therefore, in step S102, data enhancement is performed on the initial bank card dataset with the background dataset to obtain a bank card dataset. This step aims to expand the initial bank card dataset on the one hand, and simulate and generate samples influenced by the adverse factors such as uneven illumination, inclined shooting angles, complex backgrounds, image blurring and the like on the other hand, so that the finally obtained bank card dataset can comprehensively cover various possible complex conditions in practical applications, a more robust multitask recognition model can be built, and the recognition accuracy of the multitask recognition model can be improved.

Finally, in step S103, a multitask recognition model is built from the bank card dataset. In the embodiments of the present disclosure, a preset model is trained with a bank card dataset having abundant and diverse samples to obtain a multitask recognition model, where real results are labeled in advance to the bank card dataset for training and learning of the preset model. It will be appreciated that the training process of the multitask recognition model specifically includes: firstly, inputting a bank card dataset into a preset model which performs prediction on the input bank card dataset to obtain a prediction result, then comparing the prediction result with a real result labeled to the bank card dataset, and continuously and automatically updating model parameters of the model based on a comparison result. This cycle is repeated continuously until the preset model is converged, and then the converged preset model is the multitask recognition model.

Generally, the recognition model building method 100 of the present disclosure is described above with reference to FIG. 1, and in the embodiments of the present disclosure, data enhancement is performed on the initial bank card dataset with the background dataset to obtain a bank card dataset with abundant and diverse samples, and then a multitask recognition model is built from the bank card dataset. It will be appreciated that the bank card dataset with abundant and diverse samples can provide rich and diverse sample examples for the building of the multitask model. By means of these samples, the model can thoroughly learn and adapt to features and modes of the bank card under various complex environmental conditions, such as uneven illumination, inclined shooting angles, complex backgrounds, image blurring and the like, and therefore the generalization capability and recognition accuracy of the multitask recognition model are improved in practical applications. Therefore, when the multitask recognition model is applied to bank card number recognition, the bank card number can be accurately recognized based on the input image without manually inputting the bank card number by a user, thereby achieving the effect of improving the efficiency and accuracy of bank card number recognition.

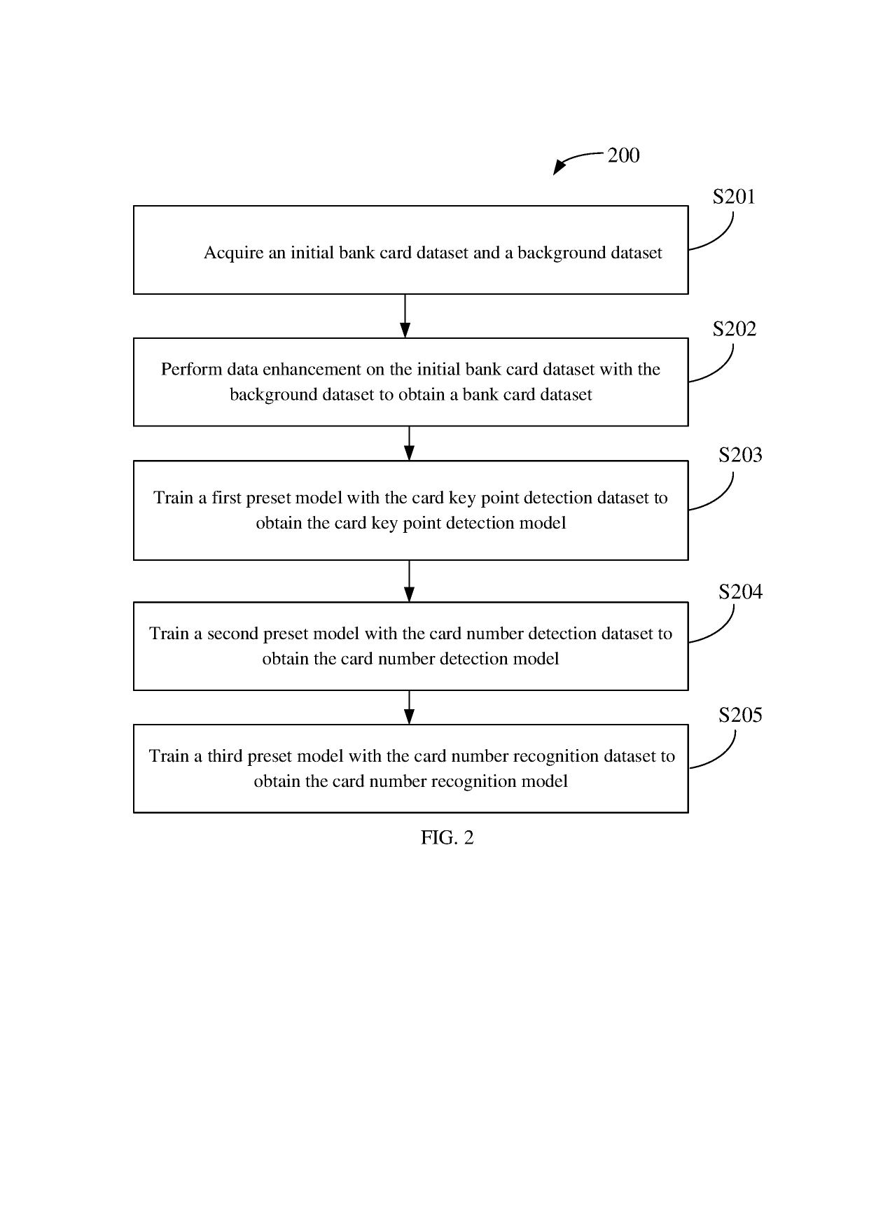

However, it should be understood by those skilled in the art that the method illustrated in FIG. 1 is exemplary and not limiting, and those skilled in the art may make adjustments as needed. Next, a process for building a multitask model with a bank card dataset is described below in conjunction with FIG. 2. FIG. 2 shows an exemplary flowchart of a recognition model building method 200 according to some embodiments of the present disclosure. As shown in FIG. 2, the method 200 includes steps S201 to S205, where steps S201 and S202 are the same as steps S101 and S102 in the method 100 described above, and steps S203 to S205 form a specific implementation of the above step S103. Therefore, the features described in conjunction with FIG. 1 can be similarly applied thereto.

It should be noted that the multitask recognition model in the embodiments of the present disclosure includes a card key point detection model, a card number detection model, and a card number recognition model. The card key point detection model is configured to perform bank card target detection and bank card vertex position detection on a bank card image. The card number detection model is configured to detect a bank card number region in the bank card image. The card number recognition model is configured to perform card number recognition on the bank card number region.

Different training datasets may be needed based on different detection purposes of different models. Specifically, the bank card dataset includes a card key point detection dataset, a card number detection dataset and a card number recognition dataset used for building the card key point detection model, the card number detection model, and the card number recognition model, respectively. Each image in the card key point detection dataset is labeled with a bank card detection box and bank card vertex positions. The bank card detection box is used to select a bank card region by a box. It will be appreciated that the bank card region specifically refers to a region range where the whole bank card is located in the image. Each image in the card number detection dataset is labeled with a bank card number region. The bank card number region refers to a specific range occupied by numbers or characters of the bank card number in the image. Based on the explanations of the bank card region and the bank card number region, the bank card region and the bank card number region represent different region ranges, respectively. Each image in the card number recognition dataset is labeled with a bank card number region and a bank card number displayed in the region. It will be appreciated that the content labeled to each dataset is a prediction target of the preset model, i.e., a predicted real result. In the training of each preset model, the prediction result is compared with the labeled real result, and model parameters of the model are continuously and automatically updated based on a comparison result until convergence, to obtain each multitask recognition model.

Therefore, based on the above definition, the building process of the multitask model is as shown in FIG. 2, where steps S201 and S202 of the method 200 are sequentially performed to obtain a bank card dataset with abundant and diverse samples. Since steps S201 and S202 are the same as steps S101 and S102 in the method 100 described above, details are omitted here and reference may be made to the foregoing description.

Next, in step S203, a first preset model is trained with the card key point detection dataset to obtain the card key point detection model. The first preset model may be a YOLOv8 Pose Estimation (YOLOv8-pose) model.

Specifically, the specific process of training the first preset model with the card key point detection dataset to obtain the card key point detection model may include: inputting the card key point detection dataset labeled with the bank card detection box and the bank card vertex positions into the first preset model, and performing, by the first preset model, bank card target detection and bank card vertex position detection on an image in the card key point detection dataset, to obtain a bank card detection box and bank card vertex positions; then comparing, by the first preset model, the detected bank card detection box and bank card vertex positions with the real bank card detection box and bank card vertex positions labeled to the image in advance, and updating model parameters of the first preset model based on the comparison result; and then skipping to the step of performing bank card target detection and bank card vertex position detection on an image in the card key point detection dataset until the first preset model is converged, to obtain the card key point detection model. It will be appreciated that the training processes for the card number detection model and the card number recognition model are the same as the training process for the card key point detection model, except that different datasets are used and the prediction purposes are different. Based on the training process for the card key point detection model, those skilled in the art can know the training processes for the card number detection model and the card number recognition model. Therefore, the training processes for the card number detection model and the card number recognition model are not repeated below.

In step S204, a second preset model is trained with the card number detection dataset to obtain the card number detection model. In an embodiment of the present disclosure, the second preset model detects the bank card number region in an image in the card number detection dataset, and labels the bank card number region in the image. For example, the detected bank card number region may be selected by a rectangular box. In some embodiments, the second preset model may adopt a Differentiable Binarization Network (DBNet) model.

In step S205, a third preset model may be trained with the card number recognition dataset to obtain the card number recognition model. In an embodiment of the present disclosure, the third preset model performs card number recognition on the bank card number region in an image in the card number recognition dataset, and outputs a recognition result of the bank card number. The recognition result is a specific value of the recognized bank card number. In some embodiments, the third preset model may use a Convolutional Recurrent Neural Network (CRNN) model.

It should be noted that the first preset model, the second preset model, and the third preset model may adopt other models besides the exemplary ones, and those skilled in the art may select suitable models as the preset models according to the actual application scenario. For example, a Transformer-based model may be adopted as the first preset model.

It will be appreciated that the above steps S203 to S205 are independent of each other and have no dependency relationship therebetween, and therefore can be executed simultaneously or in a staggered manner during implementation, which is not specifically limited in the embodiments of the present disclosure.

Generally, the recognition model building method 200 of the present disclosure is described above with reference to FIG. 2, and in the embodiments of the present disclosure, a first preset model is trained with the card key point detection dataset to obtain a card key point detection model capable of performing bank card target detection and bank card vertex position detection on a bank card image; a second preset model is trained with the card number detection dataset to obtain a card number detection model capable of detecting a bank card number region in a bank card image; and a third preset model may be trained with the card number recognition dataset to obtain a card number recognition model capable of bank card number recognition on a bank card number region in a bank card image. Further, during the bank card number recognition on the image, the multitask recognition model may be adopted sequentially to recognize the image step by step, and finally the specific value of the bank card number in the image is accurately output. Instead of manually inputting the bank card number by a user, this recognition mode can automatically and accurately recognize the specific value of the bank card number by simply inputting an image containing the bank card, thereby improving the efficiency and accuracy of bank card number recognition.

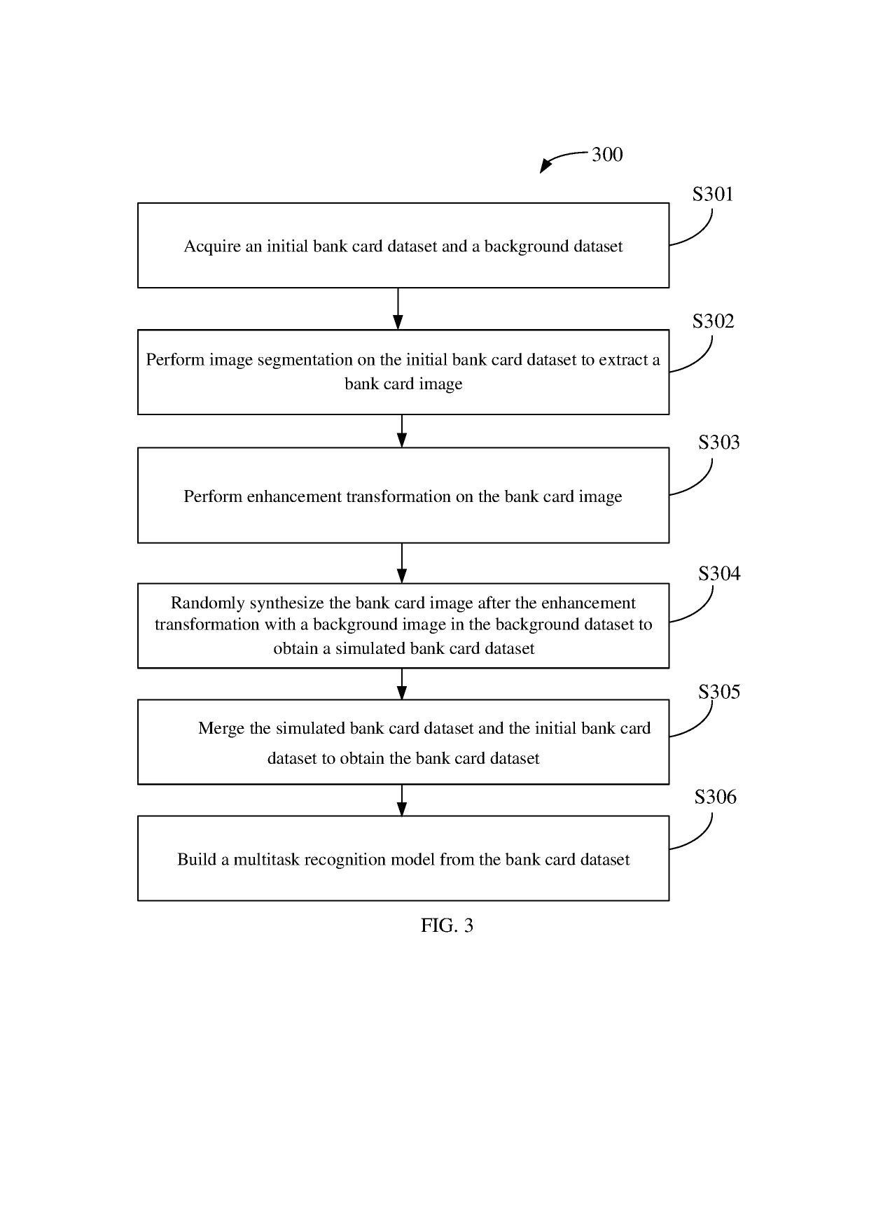

However, it should be understood by those skilled in the art that the method illustrated in FIG. 2 is exemplary and not limiting, and those skilled in the art may make adjustments as needed. Next, a specific implementation of performing data enhancement on the initial bank card dataset with the background dataset to obtain the bank card dataset is explained with reference to FIG. 3, where FIG. 3 shows an exemplary flowchart of a recognition model building method 300 according to some embodiments of the present disclosure. As shown in FIG. 3, the method 300 includes steps S301 to S306, where steps S301 and S306 are the same as steps S101 and S103 in the method 100 described above, respectively, and steps S302 to S305 form a specific implementation of the above step S102 in the method 100. Therefore, the features described in conjunction with FIG. 1 can be similarly applied thereto.

Firstly, in step S301, an initial bank card dataset and a background dataset are acquired. As can be seen from the foregoing description, the initial bank card dataset consists of images of real bank cards of users. The background dataset consists of various types of background images. This step S301 is the same as step S101 in the method 100 described above, and therefore, the acquisition of the initial bank card dataset and the background dataset may be referred to in the above description of step S101, and details are not repeated here.

Next, a specific implementation of performing data enhancement on the initial bank card dataset with the background dataset to obtain the bank card dataset (corresponding to the above step S102) is described.

In step S302, image segmentation is performed on the initial bank card dataset to extract a bank card image. In an embodiment of the present disclosure, a saliency detection model, such as a Bidirectional Refinement Network (BiRefNet) model, may be employed to perform image segmentation on each image in the initial bank card dataset, thereby extracting a bank card image. It will be appreciated that the saliency detection model can detect a bank card region in the image, and then clip the image to obtain the bank card image. As can be seen from the foregoing description, the bank card region specifically refers to a region range where the whole bank card is located in the image. In step S303, enhancement transformation is performed on the bank card image. In some embodiments, the enhancement transformation may include at least one of random rotation, scaling, Hue Saturation Value (HSV) transformation, perspective transformation, blurring or texture addition on the bank card image. The enhancement transformation aims to simulate and obtain samples under the influence of various complex environmental factors, which cover scenes such as uneven illumination, inclined shooting angles, disordered backgrounds, image blurring and the like, so that sufficient and diverse sample examples are provided for the training of the multitask recognition model.

Specifically, the random rotation means, as the name implies, rotating the bank card image at a random angle. The perspective transformation refers to an operation of projecting an image from one plane to another plane to change an angle of view and a shape of the image to make the image conform to the perspective rule. The blurring means blurring a bank card image to reduce the details and definition of the bank card image. The texture addition means adding a detailed pattern or structure with certain rules, shapes and textures on a surface of the bank card image. The specific implementation of any of the above operations is not explicitly limited in the embodiments of the present disclosure, and those skilled in the art can flexibly select and implement an appropriate implementation scheme based on the content and teaching of the embodiments of the present disclosure and in combination with their own actual needs and expertise. For example, the bank card image may be subjected to random rotation and blurring, and the blurring may be implemented by performing average filtering on the bank card image.

In step S304, the bank card image after the enhancement transformation is randomly synthesized with a background image in the background dataset to obtain a simulated bank card dataset. In an embodiment of the present disclosure, a background image may be randomly selected from the background dataset, and then attached to a back of the bank card image after the enhancement transformation as the background of the bank card image, thereby obtaining a simulated bank card image. A plurality of simulated bank card images are collected into a simulated bank card dataset.

Through the above steps S303 and S304, the bank card image is diversified to simulate the complex and changing environmental influence in reality, so that the finally generated bank card dataset not only realizes dataset expansion, but also widely covers the situations that may occur in various complex environments such as uneven illumination, inclined shooting angles, complex backgrounds, image blurring and the like. Then, a multitask recognition model is built from the bank card dataset, so that the adaptability of the multitask recognition model to different complex environmental factors can be effectively improved, and the multitask recognition model can exhibit more excellent recognition accuracy in practical applications.

In some embodiments, to obtain more simulated bank card datasets, steps S303 and S304 may be repeated multiple times for the same bank card image extracted in step S302. For example, steps S303 and S304 are repeated 50 times for the same bank card image extracted in step S302, so that one bank card image can be expanded to obtain 50 simulated bank card images.

In step S305, the simulated bank card dataset and the initial bank card dataset are merged to obtain a bank card dataset. In an embodiment of the present disclosure, the simulated bank card dataset and the initial bank card dataset are merged into one set, i.e., the bank card dataset.

In addition, it should be noted that, as can be seen from the foregoing description, the bank card dataset includes a card key point detection dataset, a card number detection dataset, and a card number recognition dataset, which are labeled with different contents for constructing different multitask models. Therefore, in some embodiments, after obtaining the bank card dataset in step S305, the bank card dataset may be labeled based on a type of bank card dataset desired to be built, to obtain a target bank card dataset corresponding to the type. Specifically, if the target bank card dataset is a card key point detection dataset, a bank card detection box and bank card vertex positions are labeled to the bank card dataset; if the target bank card dataset is a card number detection dataset, a bank card number region is labeled to the bank card dataset; and if the target bank card dataset is a card number recognition dataset, a bank card number region and a bank card number displayed in the region are labeled to the bank card dataset. For example, if a bank card dataset A obtained in step S305 is a card key point detection dataset, a bank card detection box and bank card vertex positions are labeled to each image in the bank card dataset A, to obtain the card key point detection dataset.

In other embodiments, if sufficient bank card datasets are obtained, the bank card datasets may be directly divided into three types, i.e., card key point detection dataset, card number detection dataset, and card number recognition dataset, and then the card key point detection dataset, the card number detection dataset, and the card number recognition dataset are respectively labeled with corresponding contents. For example, if a bank card dataset A is obtained in step S305, the bank card dataset A may be divided into a card key point detection dataset A1, a card number detection dataset A2, and a card number recognition dataset A3, which are then labeled with corresponding contents, respectively.

In some embodiments, after step S301, the corresponding content may be labeled to the initial bank card dataset based on a type of bank card dataset to be finally built. For example, to obtain a card key point detection dataset, a bank card detection box and bank card vertex positions are labeled to the initial bank card dataset; to obtain a card number detection dataset, a bank card number region is labeled to the initial bank card dataset; and to obtain a card number recognition dataset, a bank card number region and a bank card number displayed in the bank card number region are labeled to the initial bank card dataset. Further, after the simulated bank card image is obtained in step S304, the label content of the simulated bank card image is updated. Through the above operations, the card key point detection dataset, the card number detection dataset, and the card number recognition dataset which are labeled with the corresponding contents can also be obtained after step S305.

It should be noted that the labeling timings of the initial bank card dataset and the simulated bank card dataset are not explicitly limited in the embodiments of the present disclosure. A person skilled in the art can flexibly launch the labeling operation in any step after the initial bank card dataset and the simulated bank card dataset are obtained according to the actual situation.

Finally, in step S306, a multitask recognition model is built from the bank card dataset. The specific implementation of building the multitask recognition model may be referred to in the foregoing description, which is not repeated here.

Generally, the recognition model building method 300 of the present disclosure is described above with reference to FIG. 3, and in the embodiments of the present disclosure, by performing image segmentation on the image in the initial bank card dataset to extract a bank card image, and then performing enhancement transformation including at least one of random rotation, scaling, HSV transformation, perspective transformation, blurring or texture addition on the bank card image, and randomly synthesizing the bank card image after the enhancement transformation with a background image in the background dataset, an expanded simulated bank card dataset can be obtained, and the simulated dataset covers various complex environmental influences in reality, and finally, the initial bank card dataset and the expanded simulated bank card dataset are merged into a sufficient bank card dataset covering complex and changing environmental influences in reality. Further, the multitask recognition model built from the bank card dataset can adapt to different complex environment factors, so that the multitask recognition model can exhibit more excellent recognition accuracy in practical applications.

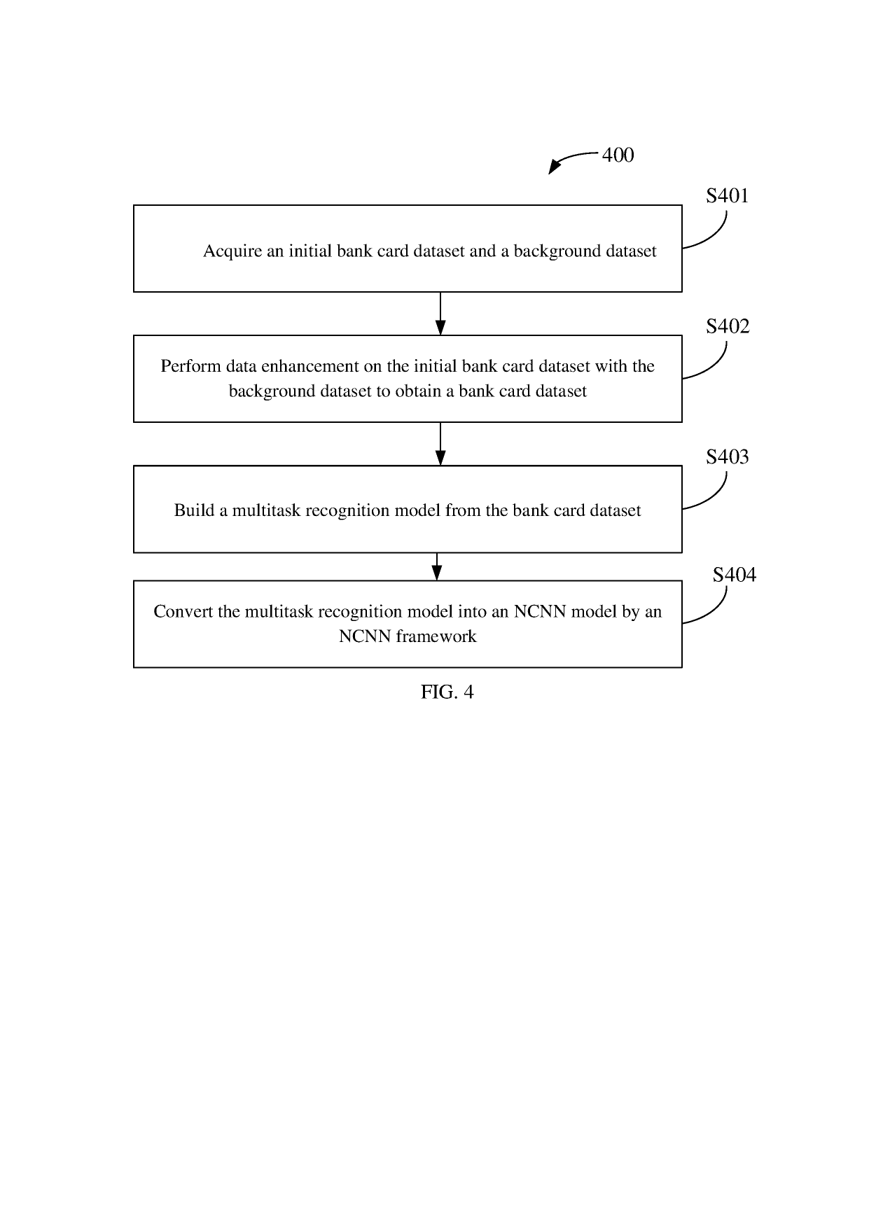

However, it should be understood by those skilled in the art that the method illustrated in FIG. 3 is exemplary and not limiting, and those skilled in the art may make adjustments as needed. A recognition model building method according to some embodiments of the present disclosure is further described below in conjunction with FIG. 4, where FIG. 4 shows an exemplary flowchart of a recognition model building method 400 according to some embodiments of the present disclosure. As shown in FIG. 4, the method 400 includes steps S401 to S404, where steps S401 to S403 are the same as steps S101 to S103 in the method 100 described above, respectively, and step S404 is an additional technical solution of the recognition model building method 100. Therefore, the features described in conjunction with FIG. 1 can be similarly applied thereto.

Firstly, at S401, an initial bank card dataset and a background dataset are acquired. Further in step S402, data enhancement is performed on the initial bank card dataset with the background dataset to obtain a bank card dataset. Next, in step S403, a multitask recognition model is built from the bank card dataset. The specific implementations of the above steps may be referred to in the corresponding description above, which are not repeated here.

Finally, in step S404, the multitask recognition model is converted into an NCNN (Neural Compute Neural Network) model by an NCNN framework. In an embodiment of the present disclosure, the NCNN framework may be used to convert the multitask recognition model into an NCNN model that can be deployed at any end side (e.g., a terminal device that can directly interact with a user, such as a mobile device, a smart wearable device, and the like) in an inference manner, thereby improving compatibility of the multitask recognition model built in the embodiments of the present disclosure.

Generally, the recognition model building method 400 of the present disclosure is described above with reference to FIG. 4, and in the embodiments of the present disclosure, by converting the multitask recognition model into an NCNN model, the multitask recognition model can be deployed on a mobile terminal such as a mobile phone or a computer, thereby improving compatibility of the multitask recognition model. Further, during checkout or transfer payment at a mobile terminal, the user only needs to input an image with the bank card, and the deployed multitask recognition model can accurately recognize the bank card number in the input image, thereby improving the efficiency and accuracy of bank card number recognition. However, it should be understood by those skilled in the art that the method illustrated in FIG. 4 is exemplary and not limiting, and that those skilled in the art may make adjustments as needed.

The present disclosure further provides a bank card number recognition method. Specifically, the method includes acquiring an input image from a user, and then recognizing a bank card number in the input image by the multitask recognition model built according to any of the above embodiments to obtain a recognition result of the bank card number. Based on the bank card number recognition method in the embodiments of the present disclosure, instead of manually inputting the bank card number, the user can simply input an image containing the bank card to allow accurate recognition of the bank card number, thereby improving the efficiency of bank card number recognition as well as the user's use experience.

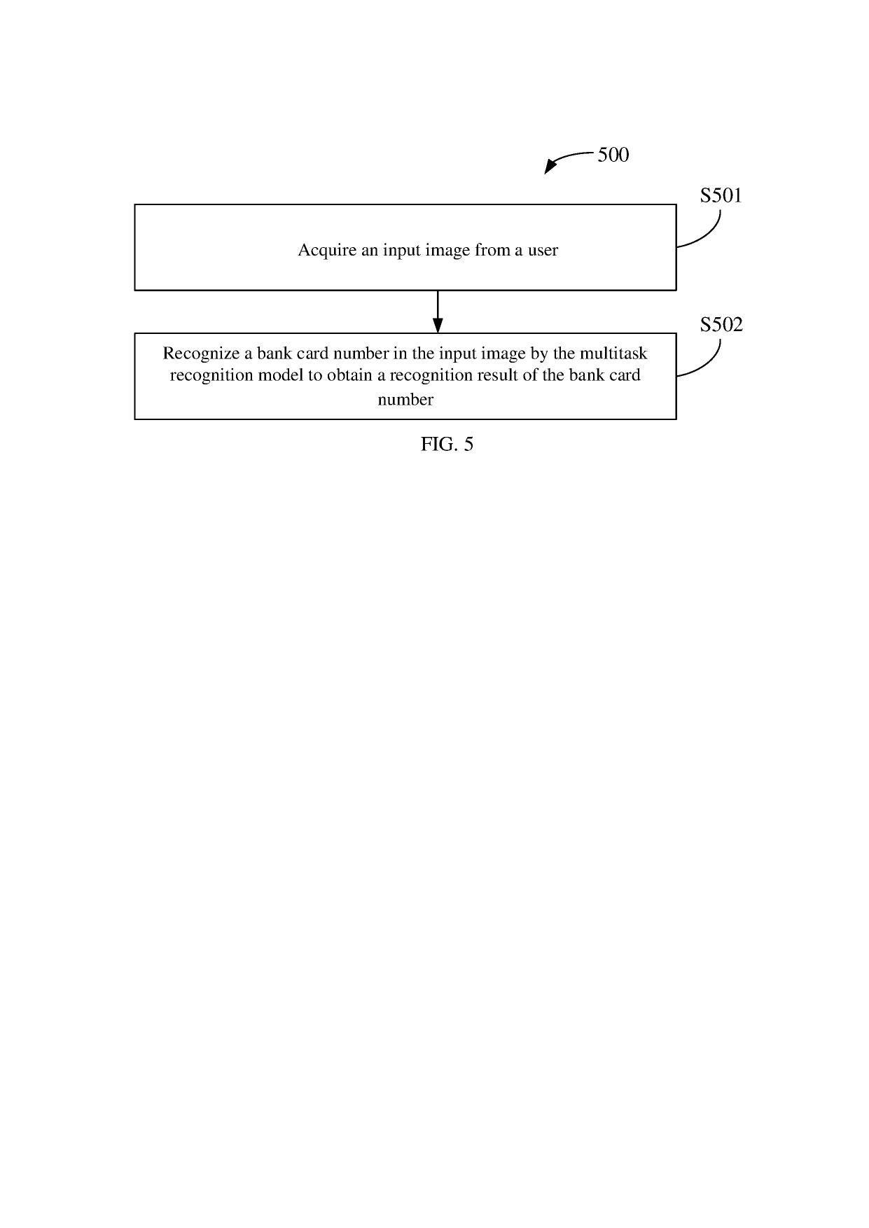

FIG. 5 shows an exemplary flowchart of a bank card number recognition method 500 according to some embodiments of the present disclosure. As shown in FIG. 5, the method 500 includes steps S501 and S502. Firstly, in step S501, an input image from a user is acquired. It will be appreciated that, ideally, the input image should contain a bank card. As an example, the bank card may be photographed by a camera provided at a mobile terminal to obtain the input image. Alternatively, an input image containing the bank card may be directly selected in an album of the mobile terminal.

Further, in step S502, a bank card number in the input image is recognized by the multitask recognition model to obtain a recognition result of the bank card number. The recognition result of the bank card number is a specific value of the bank card number. The multitask recognition model is a multitask recognition model built according to any one of the above embodiments. As can be seen from the foregoing description, the multitask recognition model can adapt to various complex environmental influences, and accurately recognize the bank card number in the input image.

Generally, the recognition model building method 500 of the present disclosure is described above with reference to FIG. 5, and in the embodiments of the present disclosure, by acquiring an input image from a user, a bank card number in the input image is recognized by the multitask recognition model built according to any of the above embodiments to obtain a recognition result of the bank card number. With this bank card number recognition method, instead of manually inputting the bank card number, the user can simply input an image containing the bank card to allow accurate recognition of the bank card number, thereby improving the efficiency of bank card number recognition as well as the user's use experience.

However, it should be understood by those skilled in the art that the method illustrated in FIG. 5 is exemplary and not limiting, and those skilled in the art may make adjustments as needed.

In some embodiments, before step S502, the multitask recognition model may be deployed locally so that when the bank card is bound, the multitask recognition model may be used to recognize the bank card number. The specific deployment mode of the multitask recognition model may be referred to in the existing art, and is not explicitly limited herein. It should be noted that the multitask recognition model is an NCNN model, which has high compatibility and can be deployed on any mobile terminal device, such as a mobile phone, a computer, a tablet, and the like.

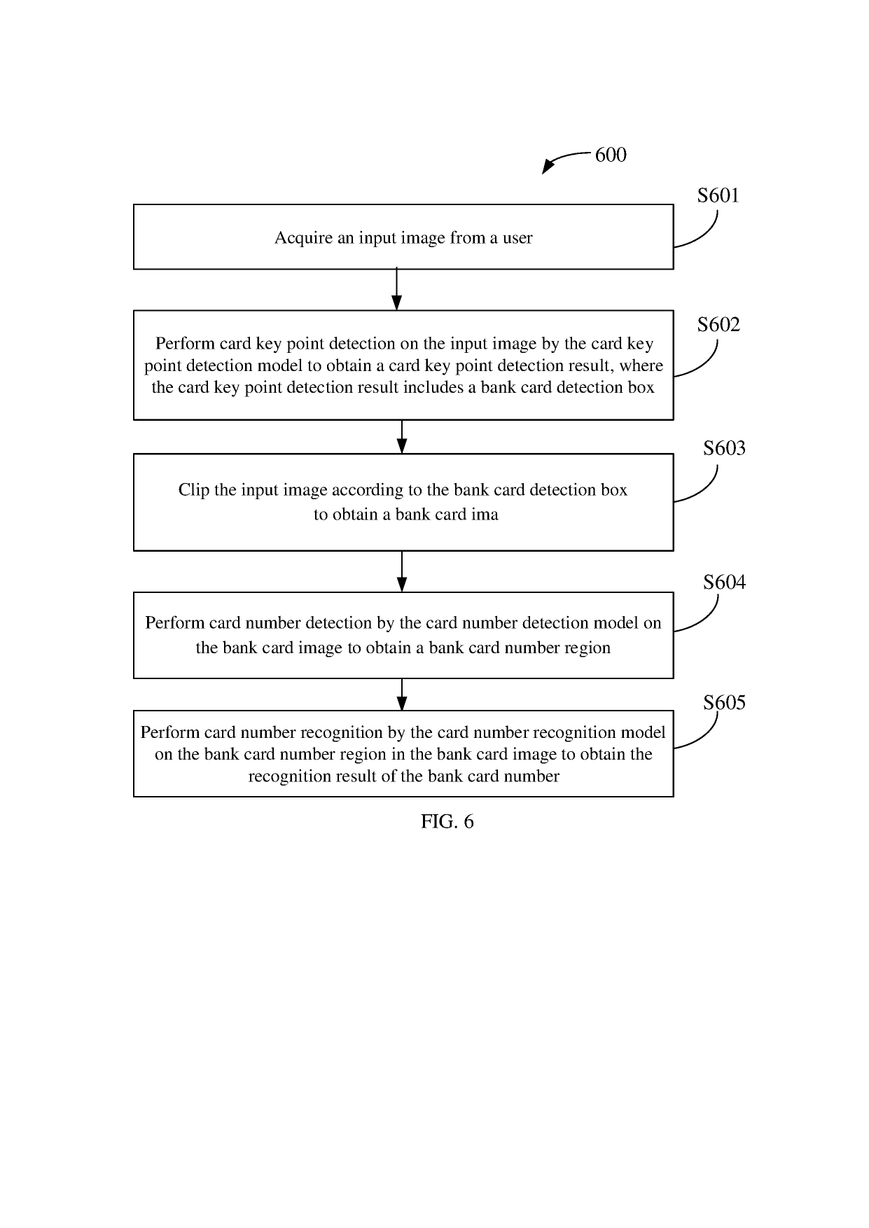

Next, a specific implementation of recognizing the bank card number in the input image by the multitask recognition model to obtain the recognition result of the bank card number is explained with reference to FIG. 6, where FIG. 6 shows an exemplary flowchart of a bank card number recognition method 600 according to some embodiments of the present disclosure. As shown in FIG. 6, the method 600 includes steps S601 to S605, where step S601 is the same as step S501 described above, and steps S602 to S605 form a specific implementation of the above step S502. Therefore, the features described in conjunction with FIG. 5 can be similarly applied thereto.

Firstly, in step S601, an input image from a user is acquired. This step is the same as step S501 in the method 500 and is not repeated here, and the related contents may be referred to in the above description.

As can be seen from the foregoing description, the multitask recognition model includes a card key point detection model, a card number detection model, and a card number recognition model. The card key point detection model is configured to perform bank card target detection and bank card vertex position detection on an image. The card number detection model is configured to detect a bank card number region in the image. The card number recognition model is configured to recognize a bank card number in the bank card number region labeled in the image.

Therefore, further in step S602, card key point detection is performed on the input image by the card key point detection model to obtain a card key point detection result. The card key point detection result includes a bank card detection box. In an embodiment of the present disclosure, when an input image is input into the card key point detection model, the card key point detection model firstly performs bank card target detection on the input image to recognize a bank card in the input image, thereby obtaining coordinates of the bank card detection box. The coordinates of the bank card detection box may be expressed by coordinates of an upper left corner and a lower right corner. Based on the coordinates of the bank card detection box, the bank card in the input image is selected by a box to obtain the bank card detection box.

In some embodiments, when the input image from the user does not include a bank card, the card key point detection model will not detect the bank card when performing bank card target detection on the input image, or when the input image from the user does not completely present a full view of the bank card, the card key point detection model may not detect all vertices of the bank card when performing vertex position detection on the input image. In the above cases, if subsequent detection on the input image is continued, on the one hand, it may be impossible to recognize the complete card number information on the bank card; and on the other hand, unnecessary memory consumption may be caused, and the detection efficiency may be reduced. Therefore, when step S602 is performed, the card key point detection model may be further used to perform bank card vertex position detection on the input image, so that a card key point detection result of the bank card vertex position can be further obtained. It will be appreciated that based on the foregoing building process of the card key point detection model, it can be determined that the card key point detection model can perform bank card target detection and bank card vertex position detection on the input image, so that repeated training of the card key point detection model is not required here. Further, after step S602, it may be firstly judged whether the bank card detection box is present in the card key point detection result. Whether the bank card detection box is present means whether a bank card is successfully detected in the input image. If the bank card detection box is not present, it indicates that no bank card is detected in the input image, and the following step S603 is not performed. Instead, the method skips to step S601 to re-acquire an input image from the user for bank card number recognition again.

Further, if the bank card detection box is present, it indicates that a bank card is detected in the input image, and a number of bank card vertex positions is further counted. If the number of bank card vertex positions is a preset threshold, for example, 4, it indicates that the input image includes a complete bank card without any omission. At this time, the following step S603 is performed. Otherwise, if the number of vertex positions of the bank cards is not the preset threshold, it indicates that the bank card in the input image has an omission. At this time, the following step S603 may not be performed, and instead, the method skips to step S601 to re-acquire an input image from the user for bank card number recognition again.

In step S603, the input image is clipped according to the bank card detection box to obtain a bank card image. In an embodiment of the present disclosure, to avoid the influence of the background environment except the bank card in the image on the subsequent detection, the input image may be clipped along a boundary of the bank card detection box, or clipped after the boundary of the bank card detection box is extended outward by a certain distance, thereby obtaining a bank card image including only the bank card.

In step S604, card number detection is performed by the card number detection model on the bank card image to obtain a bank card number region. In the embodiments of the present disclosure, the bank card image is input into the card number detection model, and then card number detection is performed by the card number detection model on the bank card image to determine a bank card number region which is selected in the bank card image by a rectangular box. As can be seen from the foregoing description, the bank card number region refers to a specific range occupied by numbers or characters of the bank card number in the input image.

Finally, in step S605, card number recognition is performed by the card number recognition model on the bank card number region in the bank card image to obtain a recognition result of the bank card number. In an embodiment of the present disclosure, a bank card image labeled with the bank card number region is input into the card number recognition model, which performs card number recognition on the bank card number region in the bank card image to determine and output a recognition result of the bank card number. It will be appreciated that the recognition result is a specific value of the bank card number.

Generally, the bank card number recognition method 600 of the present disclosure is described above with reference to FIG. 6, and in the embodiments of the present disclosure, an input image from a user is acquired; then card key point detection is performed on the input image by the card key point detection model to obtain a card key point detection result of a bank card detection box; and then the input image is clipped according to the bank card detection box to obtain a bank card image. Through these steps, the influence of the background environment except the bank card in the image can be eliminated, and the accuracy of the recognition result can be further improved. Then, card number detection is performed by the card number detection model on the bank card image to obtain a bank card number region. Finally, card number recognition is performed by the card number recognition model on the bank card number region in the bank card image to obtain a recognition result of the bank card number.

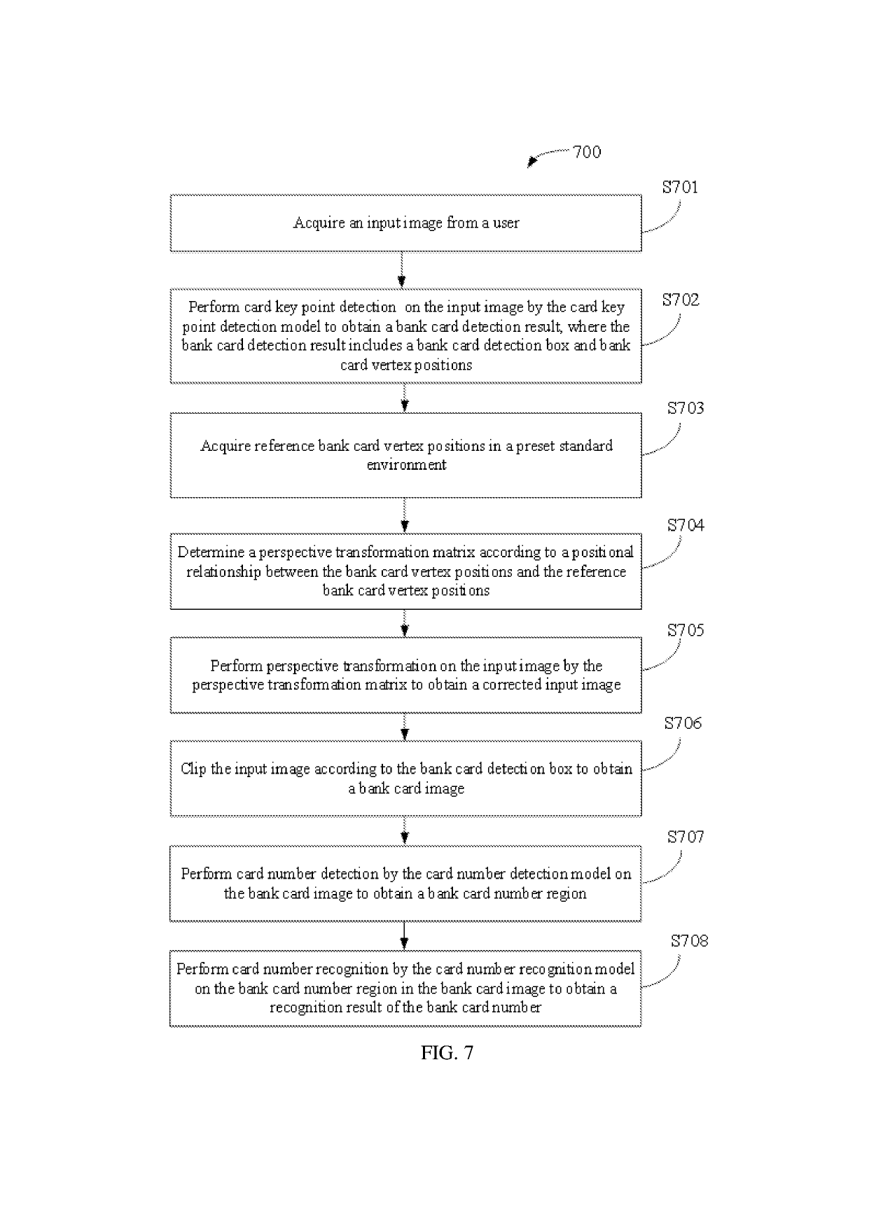

However, it should be understood by those skilled in the art that the method illustrated in FIG. 6 is exemplary and not limiting, and those skilled in the art may make adjustments as needed. A bank card number recognition method according to some embodiments of the present disclosure is further described below in conjunction with FIG. 7, where FIG. 7 shows an exemplary flowchart of a bank card number recognition method 700 according to some embodiments of the present disclosure. As shown in FIG. 7, the method 700 includes steps S701 to S708, where steps S701, S702, S706, S707 and S708 are the same as steps S601 to S605 described in the foregoing method 600, respectively, and steps S703 to S705 form an additional technical solution of the bank card number recognition method according to some embodiments of the present disclosure. Therefore, the features described in conjunction with FIG. 6 can be similarly applied thereto.

Firstly, in step S701, an input image from a user is acquired. Then, in step S702, card key point detection is performed on the input image by the card key point detection model to obtain a bank card detection result. The bank card detection result includes a bank card detection box and bank card vertex positions. Steps S701 and S702 here may be referred to in the description of steps S601 and S602 of the method 600, which are not repeated here.

Next, in step S703, reference bank card vertex positions in a preset standard environment is acquired. As an example, the reference bank card vertex positions may be obtained by performing bank card vertex position detection on a clear reference bank card image by the card key point detection model.

In step S704, a perspective transformation matrix is determined according to a positional relationship between the bank card vertex positions and the reference bank card vertex positions. In an embodiment of the present disclosure, the bank card vertex positions and the reference bank card vertex positions may be input into existing perspective transformation matrix calculation software available in the market to calculate and obtain a perspective transformation matrix from a positional relationship between the bank card vertex positions and the reference bank card vertex positions. The perspective transformation matrix may be calculated by, for example, a cv2.getPerspectiveTransform() function provided in the Open Source Computer Vision library (OpenCV).

In step S705, perspective transformation is performed on the input image by the perspective transformation matrix to obtain a corrected input image. In an embodiment of the present disclosure, the perspective transformation on the input image can correct the problems of geometric distortion, visual angle deviation, projection deformation and the like of the input image caused by factors such as a shooting angle, a camera position and the like, so that a good basis is provided for subsequent bank card number recognition, and the accuracy of bank card number recognition is further improved.

Then, in step S706, the input image is clipped according to the bank card detection box to obtain a bank card image. Further, in step S707, card number detection is performed by the card number detection model on the bank card image to obtain a bank card number region. Finally, in step S708, card number recognition is performed by the card number recognition model on the bank card number region in the bank card image to obtain a recognition result of the bank card number. Relevant contents of these three steps may refer to the corresponding description of the method 600, and are not repeated here.

Generally, the recognition model building method 700 of the present disclosure is described above with reference to FIG. 7, and in the embodiments of the present disclosure, card key point detection, including bank card target detection and bank card vertex position detection, is firstly performed on the input image by the card key point detection model to obtain a card key point detection result including a bank card detection box and bank card vertex positions; then to correct the problems of geometric distortion, visual angle deviation, projection deformation and the like of the input image caused by factors such as a shooting angle, a camera position and the like, reference bank card vertex positions in a preset standard environment are acquired, and a perspective transformation matrix is determined according to a positional relationship between the bank card vertex positions and the reference bank card vertex positions, so that perspective transformation is performed on the input image by the perspective transformation matrix to obtain a corrected input image. Then, subsequent detection is performed on the corrected input image to finally obtain a recognition result of the bank card number. The accuracy of bank card number recognition can be further improved through the above correction on the input image. However, it should be understood by those skilled in the art that the method illustrated in FIG. 7 is exemplary and not limiting, and those skilled in the art may make adjustments as needed.

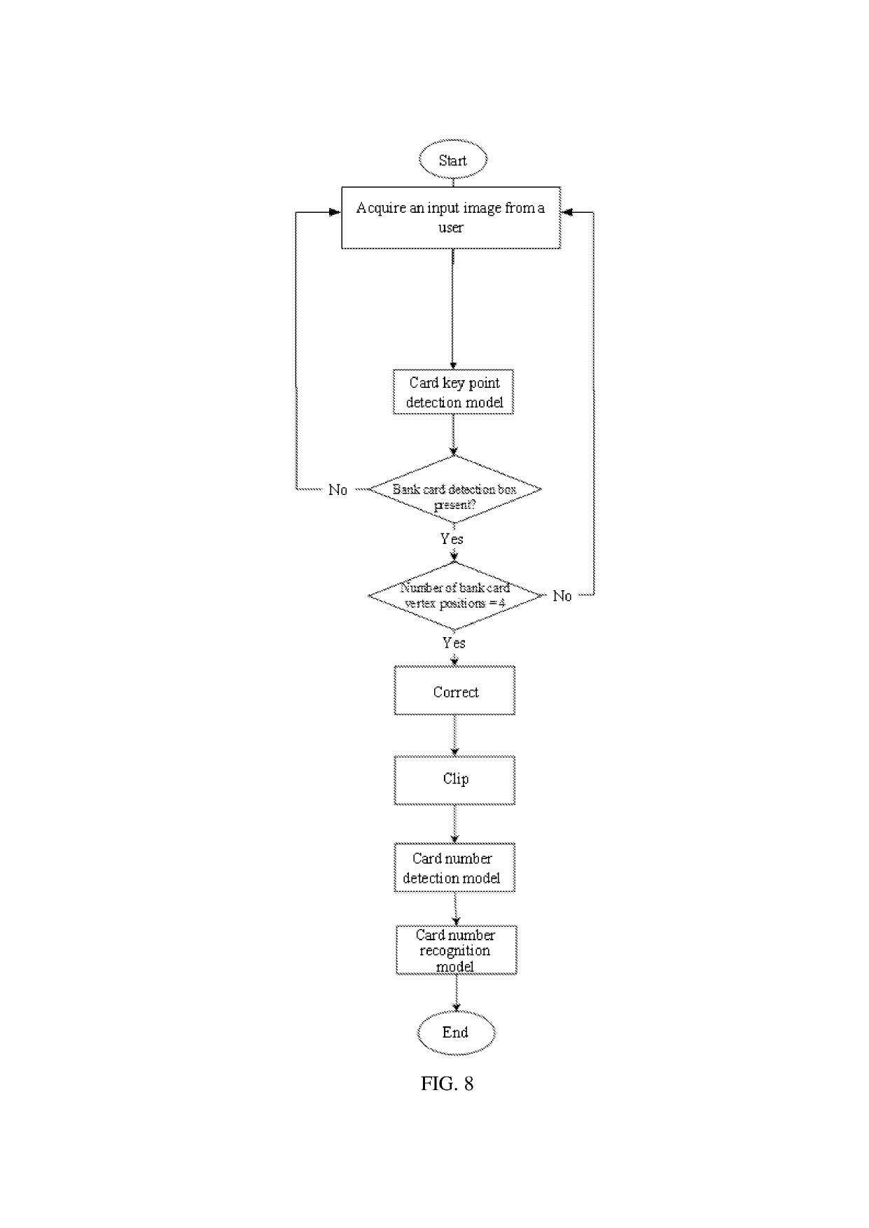

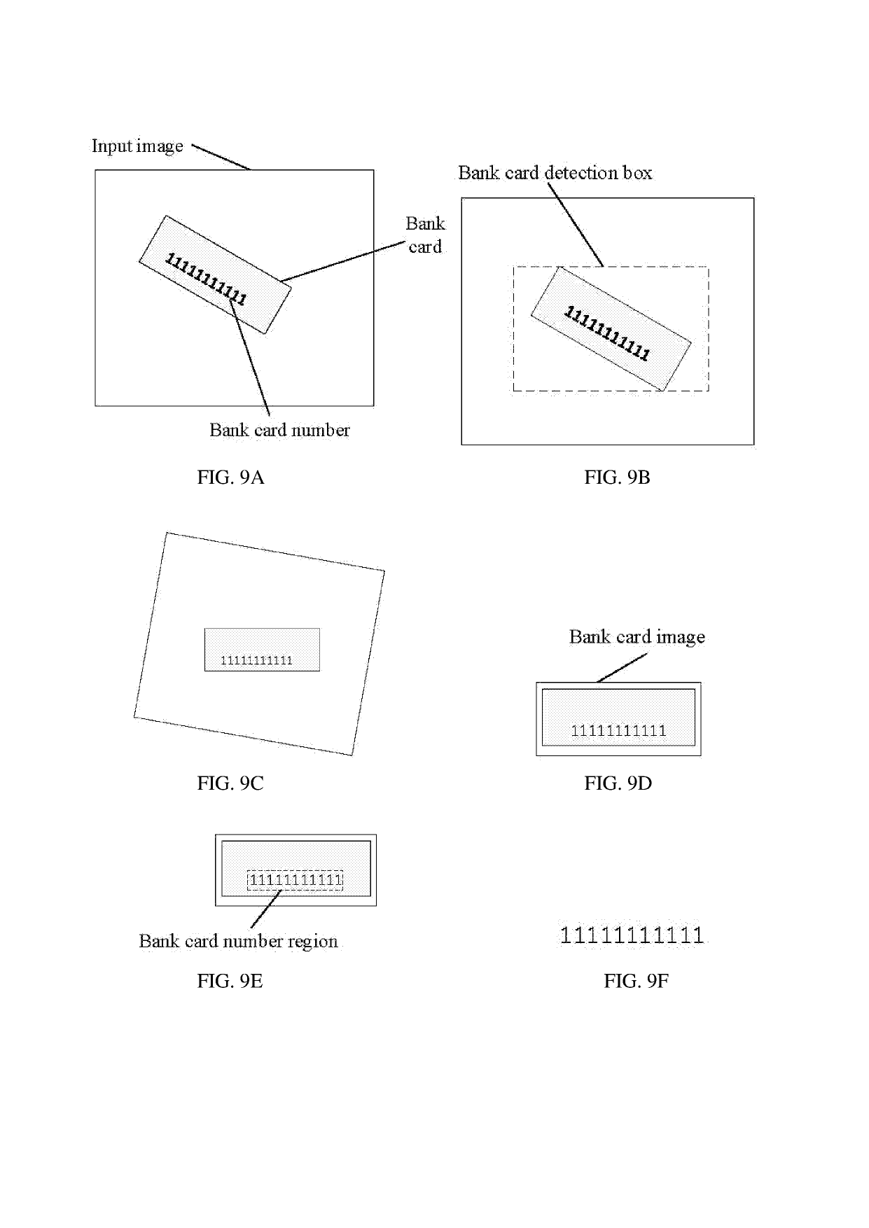

Based on the above description of the bank card number recognition method, general exemplary steps in a bank card number recognition method according to some embodiments of the present disclosure are described below in conjunction with FIGS. 8 and 9F. As shown in FIG. 8, the process begins by firstly acquiring an input image from a user. The acquired input image is as shown in diagram of FIG. 9A. Then, the input image is input into the card key point detection model to obtain a card key point detection result including a bank card detection box and bank card vertex positions, as shown in diagram of FIG. 9B. Further, it is judged whether the bank card detection box is present in the card key point detection result. If the bank card detection box is not present, the method returns to the step of acquiring an input image from the user. If the bank card detection box is present, it is further judged whether the number of bank card vertex positions is 4. If the number of bank card vertex positions is not 4, the method returns to the step of acquiring an input image from the user. If the number of bank card vertex positions is 4, the input image is further corrected. The specific correction includes: determining a perspective transformation matrix according to a positional relationship between the reference bank card vertex position and the bank card vertex position in the card key point detection result; and then performing perspective transformation on the input image by the perspective transformation matrix to obtain a corrected input image. The corrected input image is as shown in diagram of FIG. 9C. Then, the corrected input image is further clipped according to the bank card detection box to obtain a bank card image as shown in diagram of FIG. 9D. Then, the bank card image is input into the card number detection model, to obtain a bank card number region in the bank card image. The bank card number region may be referred to diagram in FIG. 9E. Finally, the bank card image is further input into the card number recognition model to recognize the bank card number in the bank card number region in the bank card image, thereby obtaining a recognition result of the bank card number. The recognition result is as shown in FIG. 9F, which is a specific value of the bank card number.

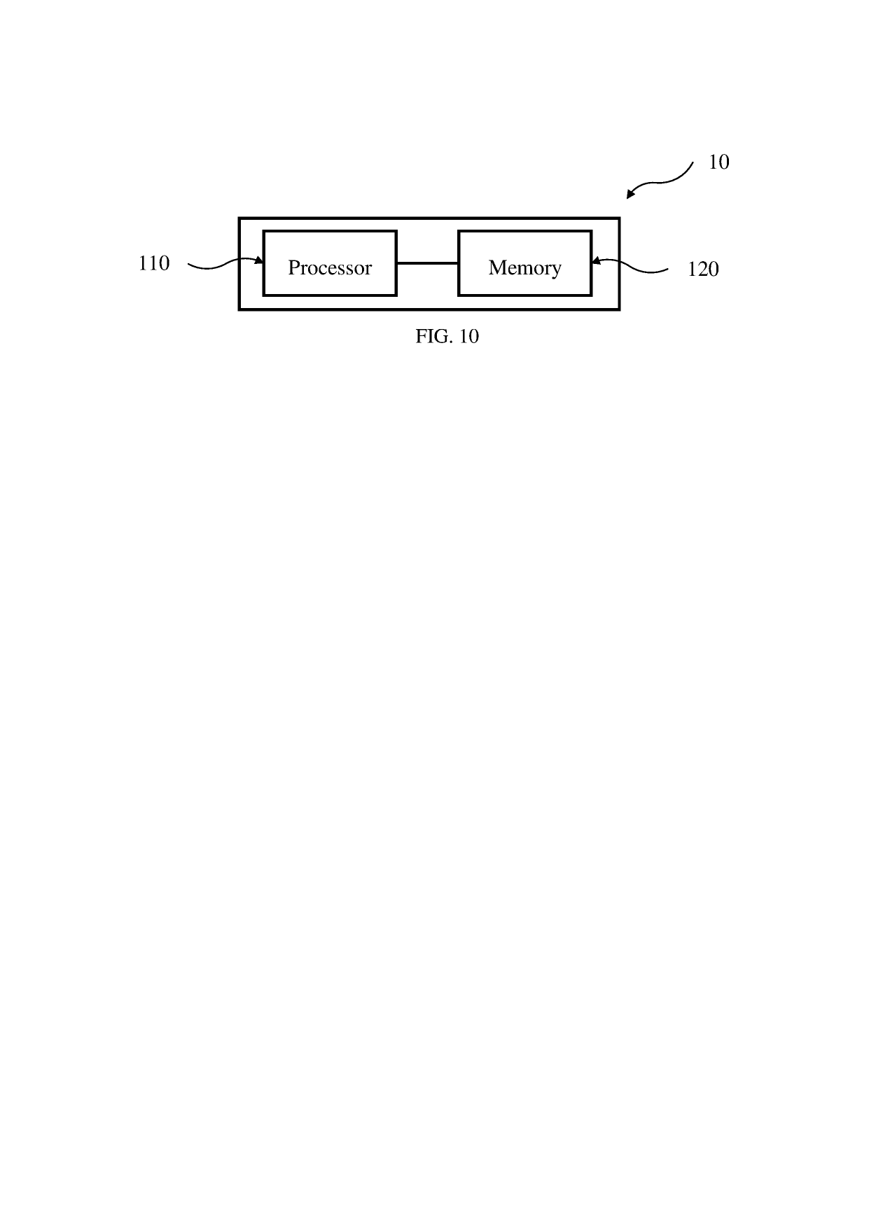

To implement the method steps of the present disclosure described above with reference to the drawings in a software and hardware level, an embodiment of the present disclosure further provides a processing apparatus, which may be an electronic device as shown in FIG. 10. FIG. 10 shows an exemplary block diagram of an electronic device 10 according to an embodiment of the present disclosure. As shown in FIG. 10, the electronic device 10 of the present disclosure may include a processor 110 and a memory 120. The memory 120 stores thereon an executable program, which can be loaded and executed by the processor 110, so that the electronic device 10 implements any of the method steps described above.

In one example scenario, the memory 120 may be controlled by the processor 110. Further, the processor 110 may be a central processing unit (CPU), an application processor (AP) or the like, integrated in the electronic device 10; while as hardware for implementing a memory function, the memory 120 may be a read only memory (ROM), a dynamic RAM (DRAM), or the like.

The present disclosure may also be implemented as a non-transitory machine-readable storage medium having program instructions stored thereon which, when executed by the processor of the electronic device, cause the processor to perform at least some steps of any method of the present disclosure described above. In an embodiment of the present disclosure, there is further provided a computer program product including computer programs or instructions which, when executed by a processor, cause the recognition model building method and the bank card number recognition method according to any embodiment of the present disclosure to be implemented.

Although various embodiments of the present disclosure have been shown and described herein, it will be obvious to those skilled in the art that such embodiments are provided by way of example only. Numerous modifications, changes, and substitutions may occur to those skilled in the art without departing from the spirit and scope of the present disclosure. It should be understood that various alternatives to the embodiments of the present disclosure described herein may be employed while practicing the present disclosure. It is intended that the following claims define the scope of the present disclosure and that equivalents or alternatives within the scope of these claims are covered thereby.

The collection and acquisition of various data in the present application are in accordance with relevant legal regulations and are authorized by a data provider. Any organization or individual that needs to obtain external data should legally obtain authorization and ensure data security, shall not illegally collect, use, process, transmit unauthorized or unprotected data, and shall not illegally buy, sell, provide or disclose unauthorized or unprotected data.

What is claimed is:

1. A recognition model building method, comprising:
acquiring an initial bank card dataset and a background dataset;
performing data enhancement on the initial bank card dataset with the background dataset to obtain a bank card dataset; and
building a multitask recognition model from the bank card dataset.

2. The recognition model building method of claim 1, wherein the multitask recognition model includes a card key point detection model, a card number detection model, and a card number recognition model; the bank card dataset includes a card key point detection dataset, a card number detection dataset and a card number recognition dataset used for building the card key point detection model, the card number detection model, and the card number recognition model, respectively; the card key point detection dataset is labeled with a bank card detection box and bank card vertex positions; the card number detection dataset is labeled with a bank card number region; the card number recognition dataset is labeled with a bank card number region and a bank card number displayed in the region; and
building the multitask recognition model from the bank card dataset includes:
training a first preset model with the card key point detection dataset to obtain the card key point detection model;
training a second preset model with the card number detection dataset to obtain the card number detection model; and
training a third preset model with the card number recognition dataset to obtain the card number recognition model.

3. The recognition model building method of claim 1, wherein performing data enhancement on the initial bank card dataset with the background dataset to obtain the bank card dataset includes:
performing image segmentation on the initial bank card dataset to extract a bank card image;
performing enhancement transformation on the bank card image, wherein the enhancement transformation includes at least one of random rotation, scaling, Hue Saturation Value (HSV) transformation, perspective transformation, blurring or texture addition;
randomly synthesizing the bank card image after the enhancement transformation with a background image in the background dataset to obtain a simulated bank card dataset; and
merging the simulated bank card dataset and the initial bank card dataset to obtain the bank card dataset.

4. The recognition model building method of claim 3, wherein after merging the simulated bank card dataset and the initial bank card dataset to obtain the bank card dataset, the method further includes:
labelling the bank card dataset based on a type of bank card dataset to obtain a target bank card dataset corresponding to the type,
wherein, if the target bank card dataset is a card key point detection dataset, a bank card detection box and bank card vertex positions are labeled to the bank card dataset; if the target bank card dataset is a card number detection dataset, a bank card number region is labeled to the bank card dataset; and if the target bank card dataset is a card number recognition dataset, a bank card number region and a bank card number displayed in the region are labeled to the bank card dataset.

5. The recognition model building method of claim 1, further comprising:
after building the multitask recognition model from the bank card dataset, converting the multitask recognition model into a Neural Compute Neural Network (NCNN) model by an NCNN framework.

6. A bank card number recognition method, comprising:
acquiring an input image from a user; and
recognizing a bank card number in the input image by the multitask recognition model built according to the method of claim 1 to obtain a recognition result of the bank card number.

7. The bank card number recognition method of claim 6, wherein the multitask recognition model includes:
a card key point detection model;
a card number detection model; and
a card number recognition model, and
wherein the recognizing of the bank card number in the input image by the multitask recognition model includes:
performing card key point detection on the input image by the card key point detection model to obtain a card key point detection result, wherein the card key point detection result includes a bank card detection box;
clipping the input image according to the bank card detection box to obtain a bank card image;
performing card number detection by the card number detection model on the bank card image to obtain a bank card number region; and
performing card number recognition by the card number recognition model on the bank card number region in the bank card image to obtain the recognition result of the bank card number.

8. The bank card number recognition method of claim 7, wherein the card key point detection result further includes bank card vertex positions; and
the bank card number recognition method further comprises, before clipping the input image according to the bank card detection box to obtain the bank card image:
acquiring reference bank card vertex positions in a preset standard environment;
determining a perspective transformation matrix according to a positional relationship between the bank card vertex positions and the reference bank card vertex positions; and
performing perspective transformation on the input image by the perspective transformation matrix to obtain a corrected input image.

9. The bank card number recognition method of claim 7, wherein the card key point detection result further includes bank card vertex positions, and
the bank card number recognition method further comprises, after performing the bank card target detection and the bank card vertex position detection on the input image by the card key point detection model:
judging whether the bank card detection box is present in the card key point detection result;
if the bank card detection box is present, determining a number of bank card vertex positions;
if the number of bank card vertex positions is a preset threshold, performing the step of clipping the input image according to the bank card detection box to obtain the bank card image;
if the number of bank card vertex positions is not a preset threshold, skipping to the step of acquiring an input image from the user; and
if the bank card detection box is not present, skipping to the step of acquiring an input image from the user.

10. The bank card number recognition method of claim 6, wherein the multitask recognition model is a Neural Compute Neural Network (NCNN) model; and
the bank card number recognition method further comprises, before recognizing the bank card number in the input image by the multitask recognition model, deploying the multitask recognition model.

11. A processing apparatus including:
a processor configured to execute program instructions; and
a memory configured to store program instructions which, when loaded and executed by the processor, cause the processor to perform:
acquiring an input image from a user; and
recognizing a bank card number in the input image by a multitask recognition model to obtain a recognition result of the bank card number;
wherein the multitask recognition model is pre-built and deployed by:
acquiring an initial bank card dataset and a background dataset;
performing data enhancement on the initial bank card dataset with the background dataset to obtain a bank card dataset; and
building the multitask recognition model from the bank card dataset.

12. The apparatus of claim 11, wherein the multitask recognition model includes a card key point detection model, a card number detection model, and a card number recognition model; and the processor is further caused to perform:
performing card key point detection on the input image by the card key point detection model to obtain a card key point detection result, wherein the card key point detection result includes a bank card detection box;
clipping the input image according to the bank card detection box to obtain a bank card image;
performing card number detection by the card number detection model on the bank card image to obtain a bank card number region; and
performing card number recognition by the card number recognition model on the bank card number region in the bank card image to obtain the recognition result of the bank card number.

13. The apparatus of claim 12, wherein the card key point detection result further includes bank card vertex positions; before clipping the input image according to the bank card detection box to obtain the bank card image, the processor is further caused to perform:
acquiring reference bank card vertex positions in a preset standard environment;
determining a perspective transformation matrix according to a positional relationship between the bank card vertex positions and the reference bank card vertex positions; and
performing perspective transformation on the input image by the perspective transformation matrix to obtain a corrected input image.

14. The apparatus of claim 12, wherein the card key point detection result further includes bank card vertex positions, and after performing bank card target detection and bank card vertex position detection on the input image by the card key point detection model to obtain the card key point detection result, the processor is further caused to perform:
judging whether the bank card detection box is present in the card key point detection result;
if the bank card detection box is present, determining a number of bank card vertex positions;
if the number of bank card vertex positions is a preset threshold, performing the step of clipping the input image according to the bank card detection box to obtain the bank card image;
if the number of bank card vertex positions is not a preset threshold, skipping to the step of acquiring an input image from the user; and
if the bank card detection box is not present, skipping to the step of acquiring an input image from the user.

15. The apparatus of claim 11, wherein the multitask recognition model is a Neural Compute Neural Network (NCNN) model.

16. A non-transitory machine-readable storage medium having program instructions stored thereon which, when loaded and executed by a processor, cause the processor to perform:
acquiring an input image from a user; and
recognizing a bank card number in the input image by a multitask recognition model to obtain a recognition result of the bank card number;
wherein the multitask recognition model is pre-built and deployed by:
acquiring an initial bank card dataset and a background dataset;
performing data enhancement on the initial bank card dataset with the background dataset to obtain a bank card dataset; and
building the multitask recognition model from the bank card dataset.

17. The storage medium of claim 16, wherein the multitask recognition model includes a card key point detection model, a card number detection model, and a card number recognition model; and the processor is further caused to perform:
performing card key point detection on the input image by the card key point detection model to obtain a card key point detection result, wherein the card key point detection result includes a bank card detection box;
clipping the input image according to the bank card detection box to obtain a bank card image;
performing card number detection by the card number detection model on the bank card image to obtain a bank card number region; and
performing card number recognition by the card number recognition model on the bank card number region in the bank card image to obtain the recognition result of the bank card number.

18. The storage medium of claim 17, wherein the card key point detection result further includes bank card vertex positions; before clipping the input image according to the bank card detection box to obtain the bank card image, the processor is further caused to perform:
acquiring reference bank card vertex positions in a preset standard environment;
determining a perspective transformation matrix according to a positional relationship between the bank card vertex positions and the reference bank card vertex positions; and
performing perspective transformation on the input image by the perspective transformation matrix to obtain a corrected input image.

19. The storage medium of claim 17, wherein the card key point detection result further includes bank card vertex positions, and after performing bank card target detection and bank card vertex position detection on the input image by the card key point detection model to obtain the card key point detection result, the processor is further caused to perform:
judging whether the bank card detection box is present in the card key point detection result;
if the bank card detection box is present, determining a number of bank card vertex positions;
if the number of bank card vertex positions is a preset threshold, performing the step of clipping the input image according to the bank card detection box to obtain the bank card image;
if the number of bank card vertex positions is not a preset threshold, skipping to the step of acquiring an input image from the user; and
if the bank card detection box is not present, skipping to the step of acquiring an input image from the user.

20. The storage medium of claim 16, wherein the multitask recognition model is a Neural Compute Neural Network (NCNN) model.
